(19) United States
(12) Patent Application Publication
(10) Pub. No.: US 2015/0345839 A1
(43) Pub. Date: Dec. 3, 2015

(54) THERMO-ADSORPTIVE BATTERY CLIMATE CONTROL SYSTEMS

(71) Applicants: Evelyn N. WANG, Cambridge, MA (US); Xiansen LI, Somerville, MA (US); Ian Salmon MCKAY, Seattle, WA (US)

(72) Inventors: Evelyn N. WANG, Cambridge, MA (US); Xiansen LI, Somerville, MA (US); Ian Salmon MCKAY, Seattle, WA (US)

(73) Assignee: MASSACHUSETTS INSTITUTE OF TECHNOLOGY, Cambridge, MA (US)

(21) Appl. No.: 14/728,989

(22) Filed: Jun. 2, 2015

Related U.S. Application Data
(60) Provisional application No. 62/006,367, filed on Jun. 2, 2014.

(51) Int. Cl. F25B 30/04; B23P 15/26; B01J 20/04; C01B 39/20; C09K 5/04; B01J 20/18

(52) U.S. Cl. CPC F25B 30/04; C09K 5/047; B01J 20/18; B01J 20/041; C01B 39/20; B23P 15/26

(57) ABSTRACT

Thermo-adsorptive batteries can provide the heating and cooling functions by taking advantage of the reversible adsorption/desorption cycles involving the pair of the zeolite adsorbent and condensable vapor adsorbate.

### CLAIM OF PRIORITY

This application claims the benefit of prior U.S. Provisional Application No. 62/006,367 filed on Jun. 2, 2014, which is incorporated by reference in its entirety.

### STATEMENT REGARDING FEDERALLY SPONSORED RESEARCH OR DEVELOPMENT

This invention was made with government support under Grant Nos. EB-001960 and EB-002026, awarded by the National Institutes of Health. The government has certain rights in this invention.

### TECHNICAL FIELD

This invention relates to thermo-adsorptive batteries.

### BACKGROUND

Recent research on reversible adsorption heat pumps (AHPs) has primarily focused on the development of more environment-friendly systems that can provide heating and cooling effects by utilizing low-grade thermal energy sources such as solar and geothermal energies or waste heat from a variety of industrial processes. See, D. I. Tchernev, in: L. B. Sand, F. A. Mumpton (Eds.), Natural Zeolites: Occurrence, Properties, Use, Pergamon Press, Elmsford, N.Y. and Oxford, 1978, vol. 45, and J. Janchen, D. Ackermann, H. Stach, W. Brosicke, Solar Energy 76 (2004) 339-344, each of which is incorporated by reference in its entirety. Although these studies involving a number of adsorbents have been well-documented for heating and cooling applications in stationary equipment or residential buildings, one of the key challenges is the development of more compact and modular AHPs that do not sacrifice their performance. See, A. O. Dieng, R. Z. Wang, Renewable and Sustainable Energy Reviews 5 (2001) 313-342, H. Demir, M. Mobedi, S. Ulku, Renewable and Sustainable Energy Reviews 12 (2008) 2381-2403, and B. Xue, Y. Iwama, Y. Tanaka, K. Nakashima, A. T. Wijayanta, K. Nakaso, J. Fukai, Experimental Thermal and Fluid Science 46 (2013) 54-63, each of which is incorporated by reference in its entirety. In particular, an emerging field of application is for transportation systems including hybrid and electric vehicles (see S. Narayanan, X. Li, S. Yang, I. McKay, H. Kim, E. N. Wang, Proceedings of the ASME 2013 Heat Transfer Summer Conference, 2013, HT2013-17472, which is incorporated by reference in its entirety).

### SUMMARY

A thermo-adsorptive battery can include an adsorbent comprising a multivalent cation-exchanged zeolite and an adsorbate. The multivalent cations can be selected from the group consisting of Mg²⁺, Zn²⁺, Cu²⁺, Ca²⁺, Sr²⁺, Ba²⁺, Al³⁺, and Fe³⁺.

In one aspect, the zeolite of the adsorbent in the thermo-adsorptive battery can be dealuminated by a weak acid. The weak acid can be selected from the group consisting of H₄EDTA, Na₂H₂EDTA, HCOOH, CH₃COOH and oxalic acid.

In another aspect, the zeolite can be desilicated by a base. The base can be selected from the group consisting of NaOH, KOH, LiOH, Ca(OH)₂, tetramethylammonium hydroxide (TMAOH), tetramethylammonium hydroxide (TEAOH), tetrabutylammonium hydroxide (TBAOH) and tetrapropylammonium hydroxide (TPAOH).

In another aspect, the zeolite can be calcined under a dry gas atmosphere. The dry gas can be selected from the group consisting of vacuum, ammonia, N₂, air, O₂, He, and Ar. The zeolite can be calcined at 400-600° C.

In another aspect, the zeolite can be hybridized with a nano metal oxide. The nano metal oxide can include MgO, CaO, BaO, or combinations thereof. The nano metal oxide can be in the form of nanospheres, nanofibers, nanocones, or nanostars.

The adsorbate of the thermo-adsorptive battery can include water, methanol, ethanol, or any combinations thereof. In certain embodiment, the adsorbate can include at least 20% of methanol. In certain other embodiment, the adsorbate can include at least 20% of ethanol.

A heating and cooling system or a desiccant for a liquid-/gas-mixture separation can also include the adsorbent comprising a multivalent cation-exchanged zeolite.

A method of making a thermo-adsorptive battery can include preparing a zeolite as an adsorbent and ion-exchanging the zeolite with multivalent cations. The multivalent cations can be selected from the group consisting of Mg²⁺, Zn²⁺, Cu²⁺, Ca²⁺, Sr²⁺, Ba²⁺, Al³⁺, and Fe³⁺.

In one aspect, the zeolite of the adsorbent in the thermo-adsorptive battery can be dealuminated by a weak acid. The weak acid can be selected from the group consisting of H₄EDTA, Na₂H₂EDTA, HCOOH, CH₃COOH and oxalic acid.

In another aspect, the zeolite can be desilicated by a base. The base can be selected from the group consisting of NaOH, KOH, LiOH, Ca(OH)₂, tetramethylammonium hydroxide (TMAOH), tetramethylammonium hydroxide (TEAOH), tetrabutylammonium hydroxide (TBAOH) and tetrapropylammonium hydroxide (TPAOH).

In another aspect, the zeolite can be calcined under a dry gas atmosphere. The dry gas can be selected from the group consisting of vacuum, ammonia, N₂, air, O₂, He, and Ar. The zeolite can be calcined at 400-600° C.

In another aspect, the zeolite can be hybridized with a nano metal oxide. The nano metal oxide can include MgO, CaO, BaO, or combinations thereof. The nano metal oxide can be in the form of nanospheres, nanofibers, nanocones, or nanostars.

Other aspects, embodiments, and features will be apparent from the following description, the drawings, and the claims.

### BRIEF DESCRIPTION OF THE DRAWINGS

FIG. 1 shows N₂ adsorption/desorption isotherms of the parent and modified Y zeolites at −196° C.

FIG. 2 shows high-field (700 MHz, ¹H)²⁷Al MAS NMR spectra of Y-type zeolites No. 1 (A), No. 2 (B) and No. 3 (C).

FIGS. 3A-C show experimental (black) and simulated (color)²⁹Si MAS NMR spectra (400 MHz, ¹H) of Y-type zeolites No. 1 (A), No. 2 (B) and No. 3 (C). Overall fittings and individual deconvoluted peaks are shown as red and dotted lines, respectively.

FIG. 4 shows water vapor adsorption/desorption isotherms of the zeolites No. 1 (A), Nos. 2 and 4 (B), and No. 3 (C) at 25, 45 and 65° C. The dotted desorption trendlines are drawn to help guide the eye.

FIG. 5 shows 2^{nd}-order polynomial fitting of mₜ/m_{equil.} vs. √t using Eq. 5 on No. 3 for water vapor at 25° C. and 2% RP derived from the pre-degassed sample mass change in response to stepwise RP increment (inset).

FIGS. 6A-C shows SEM images of zeolites No. 1 (A), No. 2 (B) and No. 3 (C) with all the scale bars of 1 μm.

FIG. 7 shows D-R plot of No. 3 at 25° C. for water vapor uptake.

FIG. 8 shows total vapor sorption isotherms of No. 3 at varying Ts (25-65° C.) for 20 wt % MeOH/H₂O mixture (A) and pure MeOH (B).

FIG. 9 shows water vapor sorption isotherms of No. 5 at 25° C. (A) and 65° C. (B) before and after multiple adsorption/desorption cycles.

FIG. 10 shows N₂ sorption isotherms of No. 5 before and after 108-fold cycles at −196° C.

FIG. 11 shows water adsorption/desorption isotherms of MgY zeolites at 25° C.

FIG. 12 shows adsorption/desorption isotherms of MgY zeolites at different running temperature for 20 wt % methanol aqueous solutions.

FIG. 13 shows adsorption/desorption isotherms of MgY zeolites at different running temperature for pure methanol.

FIG. 14 is a schematic illustration of the shape of a monolithically-integrated thermal battery designed for integration into a battery electric vehicle according to an embodiment of the invention.

### DETAILED DESCRIPTION

Today's electric vehicle (EV) batteries can only provide enough power to propel them 160 km or so on a single charging basis, a shortcoming that often leaves little leftover for cooling or warming the passengers. The existing climate control systems including conventional heating, ventilation and air conditioning (HVAC) equipped in the current EVs can reduce an EV's driving range by as much as 30%, especially in the summer seasons. Although the studies of adsorption heat pumps using a range of zeolites as adsorbents have been well-documented in the literature for thermal energy transformation for stationary equipment or residential buildings, one of the relatively new but strongly emerging applications of zeolite adsorbents is their potential utilization in mobile EVs. Thermo-adsorptive batteries (ATBs), i.e., so-called adsorption heat pumps, for cabinet climate control offer a promising approach to extend driving range of EVs by reducing electric battery power drainage. ATBs can simultaneously provide the heating and cooling functions by taking advantage of the reversible adsorption/desorption cycles involving the pair of the zeolite adsorbent and condensable vapor adsorbate. However, ATBs with considerable intrinsic gravimetric and volumetric thermal energy storage densities as well as rapid adsorption/desorption kinetics are a prerequisite for the practical implementation of such a concept. A successful implementation of this technology can be also broadly applicable to heavy-duty trucks, residential and commercial buildings for heating and cooling.

For transportation systems including hybrid and electric vehicles, adsorption heat pumps (AHPs) can extend the driving range by minimizing the electric battery power drainage, as compared to current systems which typically employ vapor compression cycles or resistive heaters, depending on the environmental condition. For the practical implementation of this adsorption based system, adsorbents must be developed with high vapor uptake capacities to maximize heating and cooling efficiencies as well as rapid adsorption/desorption kinetics for timely discharge and recharge. Additionally, parasitic energy consumption such as pumping power has to be minimized as well. The successful implementation of this technology can also be broadly applied for other transportation systems as well as residential and commercial buildings, whereby electricity consumption can be reduced during peak demand. Furthermore, with the use of eco-benign adsorbates instead of ozone-depleting fluorocarbon refrigerants, the negative environmental impact can be potentially mitigated.

Modular and compact adsorption heat pumps (AHPs) promise an energy-efficient alternative to conventional vapor compression based heating, ventilation and air conditioning systems. A key element in the advancement of AHPs is the development of adsorbents with high uptake capacity, fast intracrystalline diffusivity and durable hydrothermal stability.

A variety of adsorbents including zeolites, zeotypes, ordered mesoporous materials and metal-organic frameworks (MOFs) have been explored for AHP applications. See, H. Stach, J. Mugele, J. Janchen, E. Weiler, Adsorption 11 (2005) 393-404, M. Tatlier, A. Erdem-Senatalar, Micropor. Mesopor. Mater. 28 (1999) 195-203, A. M. W. Wojcik, J. C. Jansen, Th. Maschmeyer, Micropor. Mesopor. Mater. 43 (2001) 313-317, M. Tatlier, A. Erdem-Senatalar, Micropor. Mesopor. Mater. 54 (2002) 89-96, L. Bonaccorsi, L. Calabrese, A. Freni, E. Proverbio, Micropor. Mesopor. Mater. 167 (2013) 30-37, L. Bonaccorsi, A. Freni, E. Proverbio, G. Restuccia, F. Russo, Micropor. Mesopor. Mater. 91 (2006) 7-14, C. R. Wade, T. Corrales-Sanchez, T. C. Narayan, M. Dinc\check{a}, Energy Environ. Sci. 6 (2013) 2172-2177, and H. Furukawa, F. Gándara, Y.-B. Zhang, J. Jiang, W. L. Queen, M. R. Hudson, O. M. Yaghi, J. Am. Chem. Soc. 136 (2014) 4369-4381, each of which is incorporated by reference in its entirety. Zeolites and zeotypes are a family of microporous materials with tunable hydrophilicity/hydrophobicity, high surface area, uniform pore size distribution, interconnected pore/channel system, accessible pore volume, high adsorption capacity, ion-exchange capability and shape/size selectivity that can act as effective ion exchangers, catalysts, catalyst supports and adsorbents, etc. See, C. S. Cundy, P. A. Cox, Chem. Rev. 103 (2003) 663-701, which is incorporated by reference in its entirety. A number of zeolite or zeotype adsorbents are gaining growing attention as energy storage materials mostly in combination with water as a working fluid for such applications as heat transformers in adsorption heat pumps and thermochemical heat storage due to their superior thermal and hydrothermal stability. More importantly, as compared to mesoporous materials and MOFs, a vast majority of hydrophilic zeolites or zeotypes have better thermal and hydrothermal stability, and exhibit typical Type I sorption isotherms based on the IUPAC classification, an important characteristic to maximize adsorption capacity even in very dilute dynamic vapor streams (e.g., ˜2% RP in this study). Therefore, the pumping power for delivering continuous vapor flow in the whole AHP systems can be reduced or even eliminated in favor of the coefficient of performance (COP) enhancement.

As far as the adsorbate is concerned, water has been widely used in AHPs owing to its high latent heat of condensation, small specific volume, hydrothermal stability and eco-friendly nature. See, W. Wongsuwan, S. Kumar, P. Neveu, F. Meunier, Applied Thermal Engineering 21 (2001) 1489-1519, which is incorporated by reference in its entirety. However, pure water as an adsorbate is undesirable due to freezing concerns during the chilly winters or harsh working conditions. To overcome this limitation, it is necessary to select a suitable zeolite-compatible additive to the bulk water, allowing for freezing point (FP) depression at a relatively low dosing concentration but not at the cost of overall adsorption performance of adsorbents. Furthermore, since AHPs are more effective for heating than for cooling if the T differential is held equal, an additive that can contribute to the cooling efficiency and total vapor RP elevation should be another consideration.

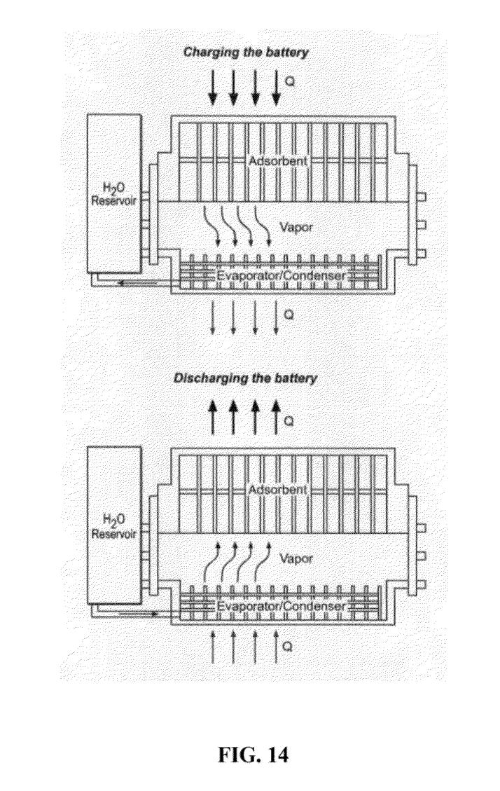

FIG. 14 shows a schematic illustration of the shape of a monolithically-integrated thermal battery designed fir integration into a battery electric vehicle according to an embodiment of the invention. As shown in FIG. 14, the ATB is a heat pump that can be charged and discharged like a battery. The unit is charged up by applying a temperature difference to the terminals. The temperature difference can be recovered at a later time by opening a valve connecting a reservoir to the adsorbent bed.

A thermo-adsorptive battery can include an adsorbent comprising a zeolite and an adsorbate. Disclosed herein is the development of high vapor uptake hydrophilic zeolite or zeotype adsorbents for ATB climate control systems by means of ion exchange, weak acid treatment, base treatment, or the use of composite materials.

The zeolite can be a multivalent cation-exchanged zeolite. The multivalent cation-exchanged zeolite is a zeolite that is ion-exchanged with multivalent cations such as Mg²⁺, Zn²⁺, Cu²⁺, Ca²⁺, Sr²⁺, Ba²⁺, Al³⁺, and Fe³⁺. For example, the ion exchange of NaY zeolites with ingoing Mg²⁺ ions can improve sorption performance by maximizing the ion exchange degree (IED). The exchanged zeolite can be a Mg,Na—Y zeolite, Zn,Na—Y zeolite, Cu,Na—Y zeolite, Ca,Na—Y zeolite, Sr,Na—Y zeolite, Ba,Na—Y zeolite, Mg,Na—Y zeolite, or Mg,Na—Y zeolite. It is found that beyond an ion exchange threshold of 64.1%, deeper ion exchange does not benefit water uptake capacity or characteristic adsorption energy, but does enhance the vapor diffusivity. In addition to using water as an adsorbate, the uptake properties of Mg,Na—Y zeolites were investigated using 20 wt % MeOH aqueous solution as a novel anti-freeze adsorbate, revealing that the MeOH additive has an insignificant influence on the overall sorption performance including the cooling efficiency and total vapor pressure enhancements. The lab-scale synthetic scalability is robust, and the tailored zeolites scarcely suffer from hydrothermal stability even after successive 108-fold adsorption/desorption cycles. The parent hydrophilic zeolites and zeotypes can include LTA-type, FAU-type, AlPO, SAPO and MeAPO, etc. Y-type zeolites finely tailored by ion exchange can bring about enhanced vapor uptake capacity, characteristic adsorption energy and intracrystalline diffusivity relative to the parent zeolites. Their uptake performance is evaluated against the adsorbate of water, methanol and dilute methanol aqueous solutions.

For ion exchange purpose, the ingoing ions mainly include multivalent cations such as Mg²⁺, Zn²⁺, Cu²⁺, Ca²⁺, Sr²⁺, Ba²⁺, Al³⁺, and Fe³⁺.

The ion exchange method includes the exchanges in liquid, solid, and vapor phases. For the latter both cases, volatile salts are selected, e.g., MgCl₂, MgBr₂, MgI₂, MgH₂, Mg(OCH₃)₂, Mg(OC₂H₅)₂. In the process of ion exchanges, some extra experimental steps of either slight dealumination by weak acids (e.g., H₄EDTA (ethylenediaminetetraacetic acid), Na₂H₂EDTA, HCOOH, CH₃COOH and oxalic acid), slight desilication by bases (e.g., NaOH, KOH, LiOH, Ca(OH)₂, tetramethylammonium hydroxide (TMAOH), tetramethylammonium hydroxide (TEAOH), tetrabutylammonium hydroxide (TBAOH) and tetrapropylammonium hydroxide (TPAOH)), or calcination at 400-600° C. under a flowing dried gas atmosphere (e.g., N₂, air, O₂, vacuum, ammonia, He, and Ar) are optionally inserted to increase the pore volume and mass transfer rate inside the adsorbents.

Finally, the modified or unmodified zeolites can be hybridized with nano metal oxides (e.g, MgO, CaO, BaO, and their combination) by means of in-situ growth or physical mixing in order to harvest the coupled physico-/chemo-adsorption heat of the composite adsorbents. The metal oxides with a range of geometries (e.g., nanosphere, nanofibers, nanocones, or nanostars) can come from direct synthesis or are thermally converted from the respective metal hydroxides, metal bicarbonate or metal carbonate, etc.

The adsorbates primarily includes pure water, pure methanol, pure ethanol or dilute methanol or ethanol aqueous solutions (e.g., 20 wt % methanol, or 20 wt % ethanol), etc.

The parent NaY-type zeolites are commercially available or homemade. It is worth noting that after each ion exchange in the solution, the sample is thoroughly washed with plenty of deionized (DI) water, followed by drying in ambient air.

A thermo-adsorptive battery can include a packed granular or continuous material that reversibly or irreversibly physisorbs or chemisorbs the refrigerant to release heat. The thermo-adsorptive battery can also include a liquid material that reversibly or irreversibly absorbs the refrigerant to release heat. A method of making a thermo-adsorptive battery can include preparing a physisorptive material including silica gel, zeolites, activated carbon, and microporous metal-organic frameworks (MOFs), or a reversible chemisorptive material including activated alumina and magnesium oxides, or an irreversible chemisorptive material including any compound that reacts exothermically with the refrigerant in the vapor phase. The method can further include preparing liquid absorbents including ammonium salts, lithium bromide, or hydrophilic ionic liquids.

A method of making a thermo-adsorptive battery can include preparing a zeolite as an adsorbent, and ion-exchanging the zeolite with multivalent cations. The multivalent cations can be selected from the group consisting of Mg²⁺, Zn²⁺, Cu²⁺, Ca²⁺, Sr²⁺, Ba²⁺, Al³⁺, and Fe³⁺.

The method can further comprise dealuminating the zeolite with a weak acid. The weak acid can be selected from the group consisting of H₄EDTA, Na₂H₂EDTA, HCOOH, CH₃COOH and oxalic acid. The method can further comprise desilicating the zeolite with a base. The base can be selected from the group consisting of NaOH, KOH, LiOH, Ca(OH)₂, TMAOH, TEAOH, TBAOH and TPAOH. The method can further comprise calcining a zeolite under a dry gas. The dry gas can be selected from the group consisting of vacuum, ammonia, N₂, air, O₂, He, and Ar. The zeolite can be calcinated at 400-600° C. The method can further comprise hybridizing the zeolite with a nano metal oxide. The nano metal oxide includes MgO, CaO, BaO, or any combinations thereof. The nano metal oxide can be nanospheres, nanofibers, nanocones, or nanostars. The nano metal oxide has at least one dimension that is less than 1 micron, less than 500 nanometers, less than 250 nanometers, less than 200 nanometers, less than 100 nanometers, less than 50 nanometers, less than 20 nanometers, or less than 10 nanometers.

For example, the parent NaY zeolites were ion exchanged twice with 1 M aqueous solution of magnesium nitrate (Sigma-Aldrich) each for 12 hrs at 80° C. under intense stirring with a solution volume/zeolite mass ratio of 20 ml/g. The resulting Mg²⁺-exchanged Y zeolites were isolated by centrifugation, decanted and then re-dispersed in DI water. The rinsing procedure was repeated 3 times. Finally, the collected zeolite powders were dried at 110° C. overnight.

Alternatively, before a 3^{rd} Mg²⁺-ion exchange of the zeolites described above at 80° C. for 12 hrs (a solution/solid ratio=20 ml/g), the zeolites were calcined in a quarts tube electrical furnace at 500° C. for 4 hrs with heating and cooling rates of 1 and 1.5° C./min, respectively, under a flowing Ar atmosphere (80 ml/min) to facilitate Mg²⁺ ions migration into small cages of Y zeolites (sodalite cages and hexagonal prisms).

The samples were analyzed using N₂ sorption, ²⁷Al/²⁹Si MAS NMR spectroscopy, ICP-AES, dynamic vapor sorption, SEM, Fick's 2^{nd} law and D-R equation regressions. Among these, close examination of sorption isotherms for H₂O and N₂ adsorbates allows us to decouple and extract some insightful information underlying the complex water uptake phenomena. Moreover, the cycling stability and bench-top synthetic scalability of these modified zeolites were evaluated.

This work shows the promising performance of the modified zeolites that can be integrated into various AHP designs for buildings, electronics, and transportation applications.

The use of zeolite or zeotype adsorbents for ATB climate control systems in mobile EVs has not been disclosed until now. The adsorbents developed here have both high adsorption capacity and adsorption heat even in very low dilute vapor environment, which directly translates into higher thermal energy storage density on the gravimetric and volumetric basis, and into higher coefficient of performance (COP). Slight dealumination, slight desilication or their combination of zeolite adsorbents can simultaneously increase the pore volume and mass transfer efficiency to some extent. Higher operating temperature can be executed on the composite metal oxide/zeolite adsorbents due to the coupled physico-/chemo-adsorption heat stored therein.

Water can be used as an adsorbate. However, a risk associated with a heat pump system that uses water as a working fluid is that refrigerant freezes in very cold temperatures. This risk can be avoided by using a mixture of an alcohol (such as methanol, or ethanol) and water as the adsorbate. The choice of non-flammable dilute methanol aqueous solutions as an alternative adsorbate guarantees the normal operation of ATBs in chilly winter seasons but not at the cost of thermal energy storage density. In this case, the evaporator can be safely run at lower temperature (e.g., below 0° C.), thereby favoring the cooling efficiency enhancement. On the other hand, the total vapor pressure is increased as a result of the addition of a small fraction of methanol in water. Moreover, if the liquid mixture is near the azeotropic point, the evaporator temperature can be made lower during system discharge, increasing the effectiveness of the heat pump system.

The high-performance zeolite or zeotype adsorbents are basically derived from commercially available or home-made base materials. The production cost of the base materials is quite cheap. Preliminary experiments show that the preparation of the end adsorbents is highly scalable and robust with a good synthetic reproducibility and a cycling stability (e.g, degradation by 2.05% at 2% RH and 65° C. after 108 cycles at 250° C. under vapor atmosphere). That is, the commercial potential of these adsorbents is quite promising in terms of cost, synthetic efficiency and cyclic stability. The scale-up synthesis is now underway in cooperation with Zeolyst Company. The potential applications of these adsorbents are not only limited to ATBs, but also include heavy-duty trucks, residential and commercial buildings, whereby heating and cooling via the proposed technique can significantly decrease electricity consumption during peak demand. Furthermore, with the use of an environmentally benign refrigerant, the negative environmental impact is also potentially mitigated. On the other hand, these materials can be also broadly applicable to adsorbent or desiccant for liquid-/gas-mixtures separation, and to catalyst in the petrochemical companies.

### Examples

### Ion-Exchange of Zeolites

Starting with NaX and NaY zeolites as the base materials, three modification conditions can be chosen:

2× Ion Exchange:

The parent zeolites were ion exchanged (from twice to 4×) with 0.5-2 M aqueous solution of magnesium salts (e.g., Mg(NO₃)₂, Mg(CH₃COO)₂, Mg(HCOO)₂, MgSO₄, and MgCl₂) each for 6-24 hrs at 70-90° C. under intense stirring with a solution volume/zeolite mass ratio of 5-50 ml/g. The resulting Mg²⁺-exchanged zeolites were isolated by centrifugation, decanted and then re-dispersed in DI water. The rinsing procedure was repeated 2-6 times. Finally, the collected zeolite powders were dried at 110° C. overnight.

2× Ion Exchange/Calcination/3rd Ion Exchange:

Before a 3rd Mg²⁺-ion exchange of zeolites (that had been Mg²⁺-exchanged twice with the ion exchange conditions same as mentioned in 1)) at 70-90° C. for 6-24 hrs (a solution/solid ratio=5-50 ml/g), the zeolites exchanged twice by Mg²⁺ ions were calcined in a quarts tube electrical furnace at 400-600° C. for 2-8 hrs with heating and cooling rates of 1 and 1.5° C./min, respectively, under a flowing inert gas (e.g., N₂, NH₃, He, and Ar) atmosphere (20-100 ml/min) to facilitate Mg²⁺ ions migration into small cages of Y zeolites.

Coupled Physico-/Chemo-Sorption Adsorbent:

MgO nanofibers/zeolite composite adsorbents: Zeolite particles were first dried at 120° C. for ca. 12 hrs. Then, 1 g of zeolite was added to 20-100 mL of amine (e.g., ethylenediamine) solvent in an autoclave and sonicated for several minutes in an ultrasonic bath. And then, 0.5-10 ml of a 0.5-2 M magnesium salt (e.g., Mg(NO₃)₂, Mg(CH₃COO)₂, Mg(HCOO)₂, MgSO₄, and MgCl₂) aqueous solution was added to the amine/zeolites suspension under intense stirring. After aging at room temp. under stirring for 1 h, the solvothermal synthesis was carried out at 100-200° C. for 6-36 h with or without rotation of the autoclave, and finally washed DI water completely. The Mg(OH)₂/zeolite composites were allowed to dry at 80° C. under vacuum. The final MgO nanofibers/zeolite composite adsorbents were obtained by calcining Mg(OH)₂/zeolite composites at 300-450° C. for 6-24 hrs.

Synthesis

The parent Y-type Zeolite No. 1 was procured from Zeolyst Corp. in the Na⁺ form (CBV100).

Preparation of No. 2:

No. 1 zeolites were ion exchanged twice with 1 M aqueous solution of magnesium nitrate (Sigma-Aldrich) each for 12 hrs at 80° C. under intense stirring with a solution volume/zeolite mass ratio of 20 ml/g. The resulting Mg²⁺-exchanged Y No. 2 zeolites were isolated by centrifugation, decantation and then dispersion in deionized (DI) water. The procedure of aqueous rinse was repeated 3 times. Finally, the collected powders (6.25 g) were allowed to dry at 110° C. overnight.

Preparation of No. 3:

Before a 3^{rd} Mg²⁺-ion exchange of No. 2 at 80° C. for 12 hrs (a solution/solid ratio=20 ml/g), it was calcined in a quartz tube electrical furnace at 500° C. for 4 hrs with heating and cooling rates of 1 and 1.5° C./min, respectively, under a flowing Ar atmosphere (80 ml/min) to facilitate the migration of Mg²⁺ ions into the small cages of the Y zeolites.

Preparation of No. 4:

As a control experiment, No. 2 zeolites subjected further to the aforementioned calcination treatment alone were herein referred to as No. 4.

Preparation of No. 5:

To explore the lab-scale synthetic scalability and reproducibility from batch to batch, a total of 52.5 g of Mg²⁺-exchanged Y Zeolite No. 5 was prepared by following the protocol of No. 3 except for utilizing much larger synthesis facilities.

### Cyclic Lifetime Assessment of No. 5

Small amounts of zeolite sample No. 5 were packed onto an aluminum block cartridge heater mounted in a closed plastic desiccator whose bottom was loaded with adequate DI water. During automated adsorption/desorption cycles, the zeolites were situated in a variable water vapor pressure environment, depending on the ambient T within the closed desiccator. One T-programmed sequential cycle encompassed raising the heater T from 30 to 250° C. with a ramping duration of 1 hr, soaking at 250° C. for 1 hr, then cooling down to 30° C. within 1 hr, and finally re-soaking at 30° C. for 1 hr. Two series of cycles (50× and 108×) were carried out to assess their long-term hydrothermal stability.

### Characterization Techniques

Gas Sorption Analysis:

Gas sorption studies were conducted to investigate the impact of ion exchange on the textural properties of these zeolites. The N₂ sorption measurements were performed at −196° C. using an automated gas sorption analyzer (Autosorb iQ₂, Quantachrome). Before the adsorption runs, each sample was degassed under vacuum (ca. 0.0014 Torr) at 370° C. for 12 h, and subsequently a compatible glass rod filler was rapidly inserted in the specimen cell to minimize the cell dead void. The BET (Brunauer, Emmett and Teller) surface area, S_{BET}, was obtained by applying the BET equation to a relative pressure (RP, P/P₀) range of 5-30% on the adsorption branch. The total pore volume, Vₜ, was evaluated from the adsorbed N₂ amount at a maximal RP of 95%. The t-plot method was used to differentiate between microporosity and mesoporosity. The micropore volume, V_{micro}, was determined by applying the t-plot method to an RP range of 20-50% on the adsorption branch of the isotherms. The slope of the t-plot (V/t) is equal to the external area, i.e., the area of those pores which does not belong to micropores. See, B. C. Lippens, J. H. de Boer, J. Catal. 4 (1965) 319-413, which is incorporated by reference in its entirety. Multilayered adsorption phenomena may take place in the mesopores, macropores and outer surface, whereas micropores which have already been filled cannot contribute to the adsorption process.

Solid-State Nuclear Magnetic Resonance (ssNMR):

²⁷Al and ²⁹Si MAS NMR experiments were respectively performed using 16.4 T (700 MHz, ¹H) and 9.4 T (400 MHz, ¹H) magnets each equipped with a home-built NMR spectrometer (courtesy of Dr. D. Ruben, FBML-MIT). Both spectra were respectively referenced with respect to 1 M Al(NO₃)₃ solution (0 ppm) and neat TMS (0 ppm). All acquired spectra were processed using RNMRP data processing software (courtesy of Dr. D. Ruben, FMBL-MIT). ²⁷Al spectra were acquired using a 3.2 mm Chemagnetics triple-resonance probe double tuned to ²⁷Al/¹H, and ²⁹Si data were acquired with a 3.2 mm home-built double resonance (²⁹Si/¹H) probe. Zeolites were ground using an agate mortar and pestle under dry N₂ gas and packed into a 3.2 mm (o.d.) ZrO₂ rotors (˜26 μl fill volume). The magic angle within the probe was set using the ⁷⁹Br resonance of solid KBr and shimmed using adamantane prior to signal acquisition.

²⁷Al MAS NMR spectra (ω_{L}/2π=223 MHz) were acquired using a Bloch experiment (see F. Bloch, Phys. Rev. 70 (1946) 460-475, which is incorporated by reference in its entirety) with a short quantitative tip angle (15°, ¹¹B γB_{I}/2π=50 kHz), a spinning frequency of 16 kHz (ωᵣ/2π) as well as between 8,192 and 64,384 co-added transients. ²⁹Si MAS NMR spectra (ω_{L}/2π=78 MHz, ²⁹Si γB_{I}/2π=50 kHz) were acquired using either Bloch or Hahn-echo experiment (see E. L. Hahn, Phys. Rev. 80 (1950) 580-594, which is incorporated by reference in its entirety), a spinning frequency of 10 kHz, 3,072 co-added transients, and a recycle delay of 60 s. All data were acquired with high-power (¹H γB_{I}/2π=83 kHz) two-pulse phase modulation (TPPM)¹H decoupling during acquisition.

Elemental Analysis (EA):

EA was conducted at the MIT Center for Materials Science and Engineering-Shared Experimental Facility (CMSE-SEF) using a Horiba Jobin Yvon ACTIVA-S inductively coupled plasma-atomic emission spectrometer (ICP-AES). Calibration solutions of specific concentrations were prepared from ICP standard solutions purchased from Sigma-Aldrich for Si, Al and Mg elements, and from Ricca Chemical Company for Na element.

Dynamic Vapor Sorption (DVS) Analysis:

Adsorption/desorption properties of various zeolites were evaluated by an automated vapor sorption analyzer (DVS Vacuum, Surface Measurement Systems Ltd.) in typical ranges of vapor RP (1-90%) and T (25-65° C.). The analyzer measured the uptake and loss of vapor gravimetrically using a delicate SMSUltraBalance with a mass sensitivity of 0.1 μg. The RP surrounding the sample was controlled by using a mass flow controller. The temperature (T) was maintained constant (±0.1° C.) by enclosing the manifold in a T-controlled incubator. The zeolite powdery sample (ca. 30 mg) was loaded into the specimen pan and then placed into the instrument. Prior to being exposed to any vapor flow, the sample was degassed in situ at 370° C. under vacuum (˜10⁻⁵ Torr) for 8-12 hrs to desorb any physisorbed moisture. Afterwards, the sample was exposed to the desired RP and the vapor uptake was monitored under dynamic vapor flow. A series of equilibrium points were acquired by directly measuring the sample weight variation in response to a stepwise RP change.

Scanning Electron Microscopy (SEM):

The morphology and particle size of the pristine and tailored Y-type zeolites were observed by an Analytical Scanning Electron Microscope (JEOL-6010LA) at an accelerating voltage of 10 or 15 kV. A gold film was sputter-coated onto these samples before imaging.

### N₂ Sorption Analyses

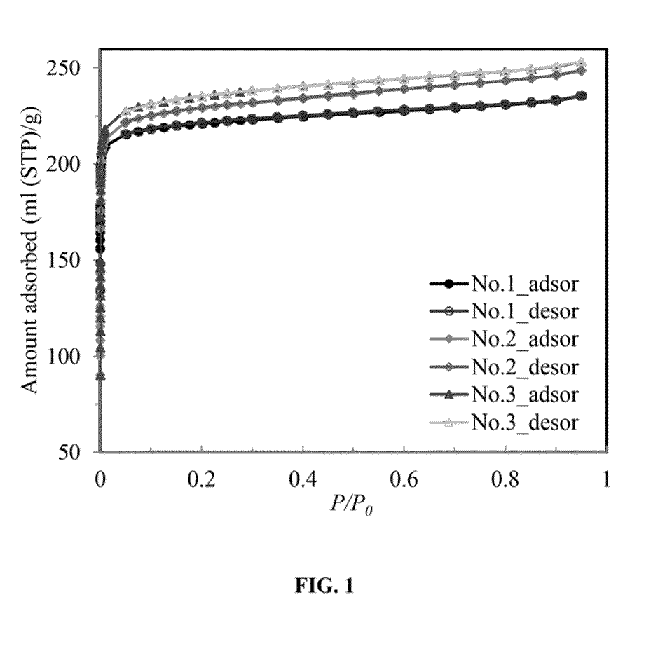

FIG. 1 shows N₂ sorption isotherms of the parent and modified Y zeolites, and the corresponding textural parameters are presented in Table 1. As illustrated in FIG. 1, all the samples exhibit Type I sorption isotherms without noticeable hysteresis loops, characteristic of the adsorption on microporous materials. As a result, such post treatments as multiple ion exchanges and calcination do not lead to the significant structural degradation primarily associated with the dealumination phenomena. Relative to the reference No. 1, a remarkable alteration of textural parameters is identified on the doubly exchanged Zeolite No. 2 (Table 1). All variables of No. 3 prepared by extra calcination, followed by a 3^{rd} ion exchange are further improved to different extents over No. 1, e.g., with an increase in V_{micro} by 5%, which can be interpreted by the smaller occupied volume of Mg²⁺ than Na⁺ and altered zeolite density. Nevertheless, the extent of incremental improvement of these parameters arising from extra tailoring of No. 3 tends to level off with respect to No. 2, thus predicting the proximity to steady-state Mg²⁺ ion exchange. It is worth noting that Sₑₓₜₑᵣₙₐₗ increases by as much as 34.5% as a consequence of the double ion exchange, and is weakly dependent on extra treatment. Basically, it is the microporosity that dictates the vapor uptake capacity at a low RP rather than the external porosity (i.e., mesoporosity).

TABLE 1
Textural parameters determined by N₂ sorption
for the parent and modified Y-type zeolites.

| | | | S_{BET} | S_{micro} | Sₑₓₜₑᵣₙₐₗ |
|---|---|---|---|---|---|
| Sample | Vₜ (ml/g) | V_{micro} (ml/g) | (m²/g) | (m²/g) | (m²/g) |
| No. 1 | 0.365 | 0.326 | 667.3 | 629.0 | 38.3 |
| No. 2 | 0.385 | 0.333 | 694.1 | 642.6 | 51.5 |
| No. 3 | 0.393 | 0.342 | 713.8 | 661.0 | 52.7 |
| No. 5 | 0.398 | 0.330 | 710.4 | 638.8 | 71.6 |
| No. 5-_108x^{a} | 0.366 | 0.326 | 668.3 | 629.1 | 39.2 |

^{a}Zeolite No. 5 after 108-fold adsorption/desorption cycles.

### ²⁷Al/²⁹Si Magic-Angle Spinning NMR (MAS NMR)

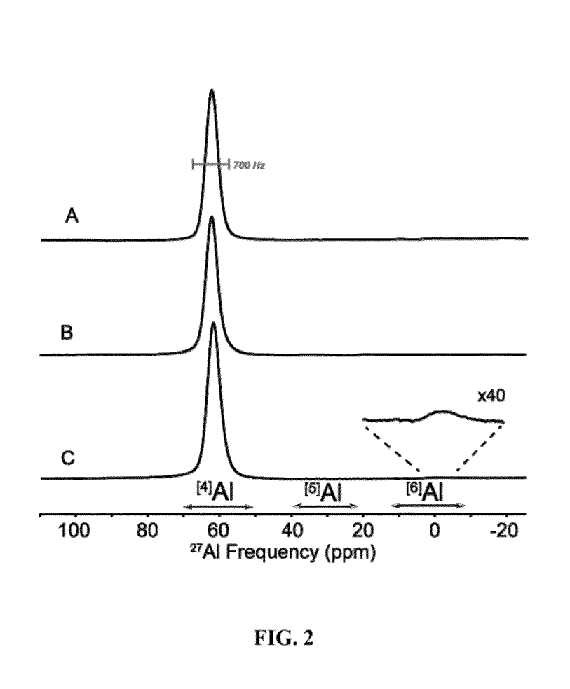

Sato et al. reported that combined NH₄⁺ ion exchange with calcination could lead to irreversible structural changes of NaY zeolites with different framework Si/Al ratios linked to dealumination and concurrent mesoporosity formation. See, K. Sato, Y. Nishimura, N. Matsubayashi, M. Imamura, H. Shimada, Micropor. Mesopor. Mater. 59 (2003) 133-146, which is incorporated by reference in its entirety. To probe the structural changes within the Y-type zeolites, all ²⁷Al MAS NMR spectra (FIG. 2) with chemical shifts sensitive to the Al coordination environments were acquired under high-fields (16.4 T) and moderately fast MAS conditions in order to minimize the quadrupolar coupling effects. See, C. A. Fyfe, J. L. Bretherton, L. Y. Lam, J. Am. Chem. Soc. 123 (2001) 5285-5291, and C. A. Fyfe, J. L. Bretherton, L. Y. Lam, Chem. Commu. 17 (2000) 1575-1576, each of which is incorporated by reference in its entirety. ²⁷Al MAS NMR spectra show an intense four-coordinate Al resonance assigned to Al in the zeolite framework with a chemical shift (δ_{cgs}) of 62 ppm, which is consistent with other reports of NaY zeolites. See, J. Klinowski, C. A. Fyfe, G. C. Gobbi, J. Chem. Soc., Faraday Trans. 1, 81 (1985) 3003-3019, and J. A. van Bokhoven, A. L. Roest, D. C. Koningsberger, J. T. Miller, G. H. Nachtegaal, A. P. M. Kentgens, J. Phys. Chem. B 104 (2000) 6743-6754, each of which is incorporated by reference in its entirety. The symmetric and narrow Al resonance with an isotropic chemical shift (δᵢₛₒ) of 63 ppm (˜700 Hz in full-width at half-maximum) has an experimentally determined quadrupolar coupling constant (C_{Q}) of 2 MHz, accounting for the quadrupole-induced shift. See, H. Demir, M. Mobedi, S. Ulku, Renewable and Sustainable Energy Reviews 12 (2008) 2381-2403, which is incorporated by reference in its entirety. For all three zeolites, the ²⁷Al spectra show >99% framework Al species. As presented in Table 2, a small fraction of extra-framework six-coordinate Al species (<0.3%, ˜0 ppm) is present in the sample No. 3. Minor dealumination of No. 3 is in good agreement with N₂ sorption analyses (vide supra). This dealumination is mainly attributed to the calcination given that the integrity of No. 2 remains intact after double ion exchanges.

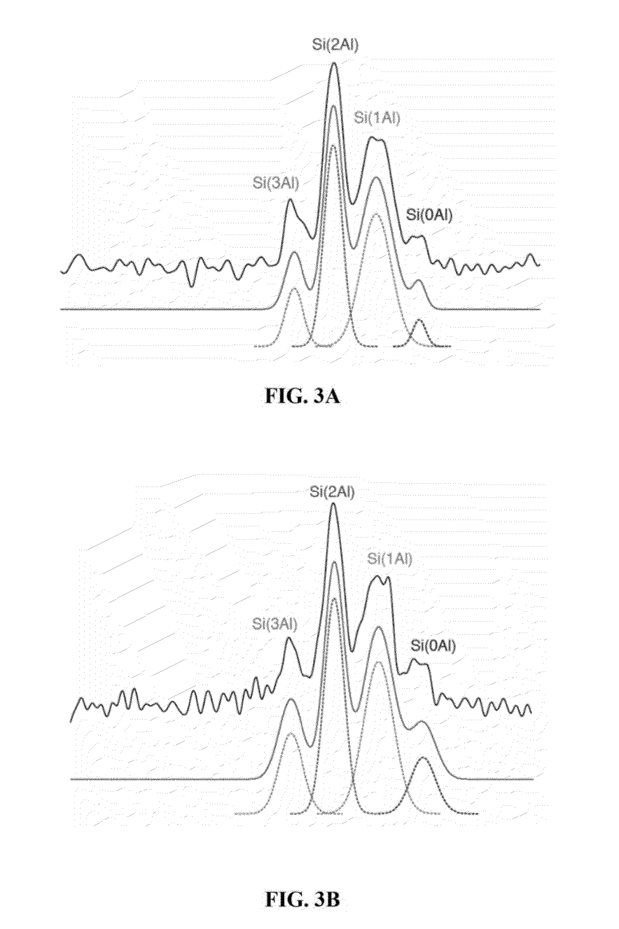

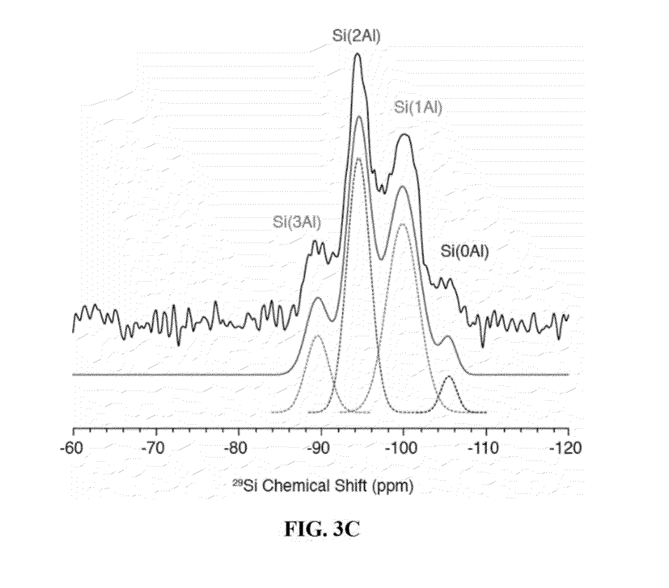

²⁹Si MAS NMR has been used to identify the Si(nAl) medium-range ordering as an acceptable tool for quantifying the framework Si/Al ratio of Al-rich zeolites. See, J. Klinowski, J. M. Thomas, C. A. Fyfe, G. C. Gobbi, Nature 296 (1982) 533-536, E. Lippmaa, M. Magi, A. Samoson, G. Engelhardt, A.-R. Grimmer, J. Am. chem. Soc. 102 (1980) 4889-4893, and E. Lippmaa, M. Mägi, A. Samoson, M. Tarmak, G. Engelhardt, J. Am. chem. Soc. 103 (1981) 4992-4996, each of which is incorporated by reference in its entirety. ²⁹Si MAS NMR spectra (79 MHz, ²⁹Si) are shown in FIGS. 3A-C for Nos. 1, 2 and 3, indicating well-resolved Si(nAl) resonances where n (n=0-4) is the number of Al atoms linked to Si via oxygen bridges to the central Si atom. The four resonances are assigned to Si(3Al), Si(2Al), Si(1Al) and Si(0Al) units with the isotropic chemical shifts of −89, −94, −100 and −105 ppm, respectively, as found in J. Klinowski, J. M. Thomas, C. A. Fyfe, G. C. Gobbi, J. S. Hartman, Inorg. Chem. 22 (1983) 63-66, which is incorporated by reference in its entirety. Deconvoluting the resonances gives a framework Si/Al ratio of ˜2.5 (Table 2), which is comparable to several typical Y-type zeolites. See, C. A. Fyfe, J. L. Bretherton, L. Y. Lam, J. Am. Chem. Soc. 123 (2001) 5285-5291, J. Klinowski, C. A. Fyfe, G. C. Gobbi, J. Chem. Soc., Faraday Trans. 1, 81 (1985) 3003-3019, and J. A. van Bokhoven, A. L. Roest, D. C. Koningsberger, J. T. Miller, G. H. Nachtegaal, A. P. M. Kentgens, J. Phys. Chem. B 104 (2000) 6743-6754, each of which is incorporated by reference in its entirety. As expected, upon increasing the steps of treatment, both peak symmetry and resolution of these four resonances turn out to degrade, suggesting distorted local Si environments due to polarization from the closest highly charged extra-framework Al species.

### Elemental Analyses

It is well-known that exhaustive ion exchange of Na⁺ with Mg²⁺ from Y-type zeolites without any concomitant structural disintegration has posed a grand challenge until now. See, B. Coughlan, W. M. Carroll, J. Chem. Soc., Faraday Trans. 1, 72 (1976) 2016-2030, which is incorporated by reference in its entirety. In general, approximately 30% of the Na⁺ ions residing in small cages (sodalite cages and hexagonal prisms) cannot be readily exchanged under conventional hydrothermal exchange conditions. This result is anticipated because both hydrated Mg²⁺ and Na⁺ ions are too bulky to diffuse through the 6-membered-ring (6MR) windows with a free diameter of 2.5 Å that are the entrances to these small cages. Moreover, more energy is required to strip the hydration shell from the smaller Mg²⁺ cations. To quantify the ion exchange degree (IED), the bulk elemental composition of the zeolites based on ICP technique is presented in Table 2. From ICP analysis, the bulk Si/Al and Na⁺/Al ratios of No. 1 are 1.95 and 1.15, respectively. The residual NaOH originating from the preceding hydrothermal preparation in alkaline media is responsible for the Na⁺/Al ratio slightly greater than unity. The doubly exchanged No. 2 zeolites yield an IED of 64.1%, whereas that of 71.5% is accomplished for No. 3, which is in line with the well-established IED for FAU-type zeolites. See, H. S. Sherry, J. Phys. Chem. 72 (1968) 4086-4094, which is incorporated by reference in its entirety. During calcination of the zeolites at 500° C. for 4 hrs, an inter-cage ion exchange between Na⁺ and Mg²⁺ ions could take place, thus slightly enhancing the IED. It is worth noting that there are small deviations in the measured Si/Al ratio between the ICP and NMR methods (Table 2), as encountered by other researchers. See, C. Wu, K. Chao, J. Chem. Soc. Faraday Trans. 91 (1995) 167-173, and T. Maruo, N. Yamanaka, N. Tsunoji, M. Sadakane, T. Sano, Chem. Lett. 43 (2014) 302-304, each of which is incorporated by reference in its entirety. The exact reason for these small discrepancies remains unclear. This technique of sequential exchange, calcination and re-exchange to produce low-Na⁺Y zeolites is also applicable for other cations provided that the inhibition from replacing Na⁺ in the small cages is not due to the bare ion size of the ingoing cations. On the other hand, the co-generation of trace amounts of protons is observed presumably due to the over-washing of zeolites in between ion exchanges and to the slight hydrolysis of the exchanged Mg²⁺ ions caused by polarizing adsorbed water in the strong electrostatic field between the exchanged cations and the framework [AlO₂]⁻ anion. See, J. W. Ward, J. Catal. 10 (1968) 34-46, which is incorporated by reference in its entirety. Hydrolytic cleavage of the Si—O—Al bonds frequently occurs at these protonated sites in the zeolite framework, leading to the undesirable dealumination under steaming conditions. See, M. Guisnet, Q. L. Wang, G. Giannetto, Catal. Lett. 4 (1990) 299-302, which is incorporated by reference in its entirety. As a consequence, multiple exchanges in conjunction with calcination lead to gradual leaching of some labile Al³⁺ species from the crystal lattice (Table 2).

TABLE 2
Elemental composition and IED of the parent and modified zeolites
determined by ²⁹Si/²⁷Al MAS NMR spectroscopy and ICP.

| | NMR data | | | ICP data | | | |
|---|---|---|---|---|---|---|---|
| Zeolite | (Si/Al)_{NMR} | ^{[4]}Al | ^{[6]}Al | (Si/Al)_{ICP} | (Na⁺/Al)_{ICP} | (H⁺/Al)_{ICP} | IED (%) |
| No. 1 | 2.50 | 100% | 0% | 1.95 | 1.15 | 0 | — |
| No. 2 | 2.54 | 100% | 0% | 2.09 | 0.359 | 0.028 | 64.1 |
| No. 3 | 2.47 | 99.7% | <0.3% | 2.15 | 0.285 | 0.045 | 71.5 |

### Dynamic Vapor Sorption Analyses

Water Uptake Performance:

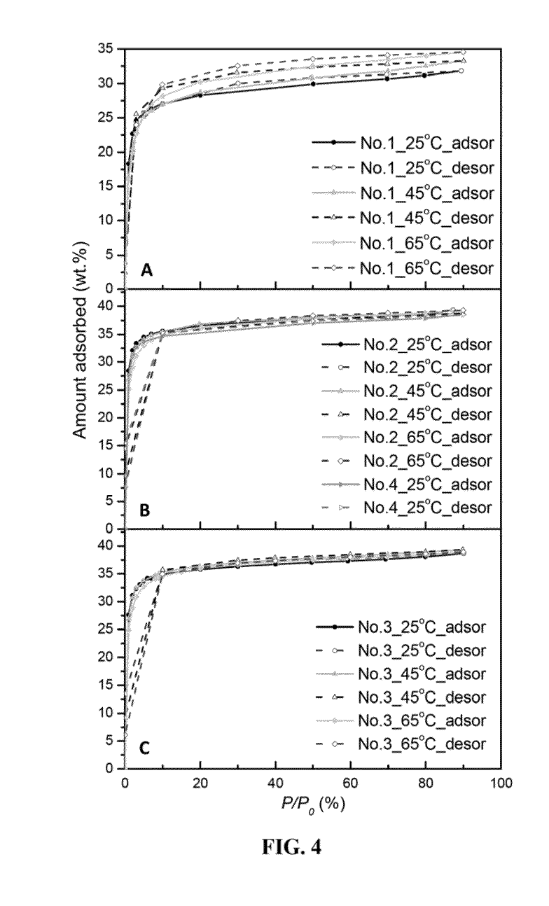

For NaY zeolites exchanged with divalent Mg²⁺ cations, one could expect a higher adsorption capacity than with Na⁺ because two Na⁺ cations are simultaneously replaced by a single Mg²⁺ while ignoring the potential hydrolysis of Mg²⁺. Meanwhile, the ionic radius of Mg²⁺ (0.66 Å) is smaller than that of Na⁺ (0.97 Å). Therefore, the net volume occupancy by these Mg²⁺ ions should be less than one third as with Na⁺. On the other hand, the electrostatic field strength inside the zeolite channels and cavities would be enhanced as a result of increased effective electric charge of ingoing Mg²⁺ cations. Water sorption isotherms of No. 1, Nos. 2 and 4, as well as No. 3 as functions of T and RP are shown in FIGS. 4 A, B and C, respectively, whereas Table 3 lists the representative uptake capacities and Ds at the working RP of 2%. Except for the isotherms of No. 1 that show hysteresis loops stemming from the smaller D of desorption, all of the other sorption profiles exhibit quite similar Type I isotherms, an attribute of microporous zeolites. Within the narrow T interval under study, the uptake capacity is weakly T dependent at a fixed RP, but is a function of RP. Nevertheless, it is worth noting that the uptake amount in the low RP regime is a little more sensitive to T than that in the high RP range since adsorption phenomena on zeolites are strongly exothermic processes with isosteric heats of adsorption highly dependent on the sorbate surface coverage. As expected, ion exchange is one of the most straightforward and robust ways to effectively boost the uptake amount, especially in the low RP region (Table 3). The uptake comparison between Nos. 2 and 3 indicates that a slightly deeper IED does not have a favorable effect on the uptake capacity, which can be explained by the minute degree of dealumination, the exchange-induced Al leaching and a small fraction of calcination-induced bare Mg²⁺ ion migration into water-inaccessible hexagonal prisms for the latter (FIG. 2C and Table 2). It is found that calcination and protonated sites are two dominant factors of dealumination, yielding Zeolite No. 4 with the smallest water uptake at 2% RP and 25° C. among Nos. 2, 3 and 4 (Table 3). Conversely, as clearly shown in FIG. 4C, the desorption T for zeolite adsorbents strongly affects the final degree of regeneration. For instance, 6.1 wt % of strongly bound water still remains entrapped inside the zeolite intracrystalline voids after the last desorption step at 65° C. under vacuum for 2 hrs without introducing any dynamic water vapor flow.

TABLE 3
Sorption capacity and D of the zeolites with and without tailoring
for water vapor at different operating Ts and RPs.

Adsorption
capacity (wt %)

| Zeolite | T (° C.) | 2% RP | 90% RP | D at 2% RP (cm²/s) |
|---|---|---|---|---|
| No. 1 | 25 | 22.66 | 31.79 | 7.06 × 10⁻¹³ |
| | 45 | 20.51 | 33.28 | 9.96 × 10⁻¹³ |
| | 65 | 19.84 | 34.56 | 1.13 × 10⁻¹² |
| No. 2 | 25 | 32.09 | 39.28^{a} | 9.14 × 10⁻¹³ |
| | 45 | 30.76 | 38.73 | 1.09 × 10⁻¹² |
| | 65 | 29.02 | 39.24 | 1.25 × 10⁻¹² |
| No. 3 | 25 | 31.97 | 38.97 | 1.94 × 10⁻¹² |
| | 45 | 30.71 | 39.32 | 1.99 × 10⁻¹² |
| | 65 | 28.86 | 38.91 | 2.46 × 10⁻¹² |
| No. 4 | 25 | 31.35 | 38.44 | 9.04 × 10⁻¹³ |

^{a}The data was acquired at 87.3% RP.

Intracrystalline Diffusivity (D) and SEM Observation:

The charging/discharging kinetics of zeolites is as crucial as their adsorption capacity to achieve highly efficient AHP systems. Fick's 2^{nd} law of diffusion (Eq. 1) describing non-steady-state mass transfer is used to determine D

$$\frac{\partial c}{\partial t} = D \frac{{\partial }^{2} c}{\partial {x}^{2}} \qquad ( 1 )$$

For the purpose of measuring D in powdered zeolite samples, spherical geometry, constant D and constant source concentration are assumed, resulting in the following Eq. 2 in a spherical coordinate system

$$\frac{\partial c}{\partial t} = \frac{1}{{r}^{2}} \frac{\partial }{\partial r} ( {Dr}^{2} \frac{\partial c}{\partial r} ) \qquad ( 2 )$$

Using the additional boundary conditions of m=0 at t=0, m=m_{equil.} at t=∞, and δc/δr=0 at r=0 (i.e., no concentration gradient at the center of the sphere), Eq. 2 has the following solution (see, R. H. Perry, D. W. Green (Eds.), Perry's Chemical Engineers' Handbook, 7th Edition, McGraw-Hill, 1997, which is incorporated by reference in its entirety)

$$\frac{{m}_{t}}{{m}_{equil .}} = 1 - \frac{6}{{π}^{2}} {\sum }_{n = 1}^{∞} ( \frac{1}{{n}^{2}} ) exp ( - \frac{{n}^{2} {π}^{2} Dt}{{r}^{2}} ) \qquad ( 3 )$$

where r is the particle radius. For short times, Eq. 3 can be simplified into

$$\begin{matrix}\frac{{m}_{t}}{{m}_{equil .}} = \frac{6}{r} \sqrt{\frac{Dt}{π}} ( \frac{{m}_{t}}{{m}_{equil .}} < 0.2 ) \\ or & ( 4 ) \\ \frac{{m}_{t}}{{m}_{equil .}} = \frac{6}{r} \sqrt{\frac{Dt}{π}} - \frac{3 Dt}{{r}^{2}} ( 0.2 < \frac{{m}_{t}}{{m}_{equil .}} < 0.8 ) & ( 5 )\end{matrix}$$

where mₜ/m_{equil.} is the ratio of the mass at a given time t to that at an infinite time (i.e., equilibrium mass). For the analysis, Eq. 5 is chosen because it is valid over a wider range of mₜ/m_{equil.} values.

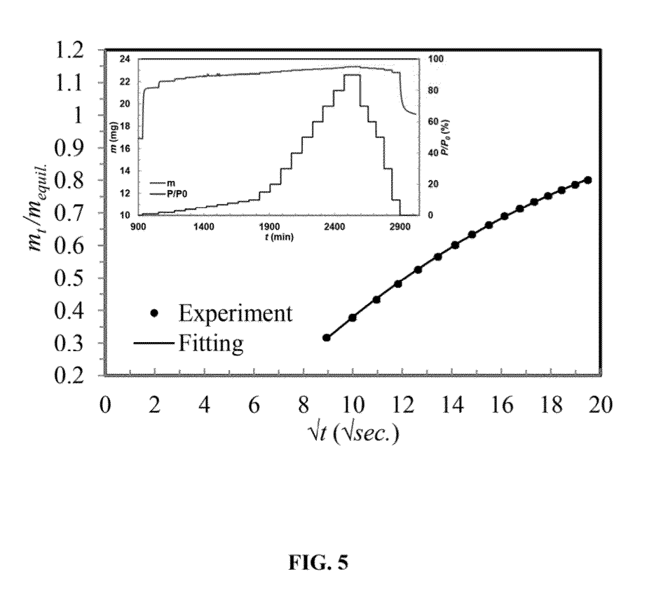

Second-order polynomial fitting of mₜ/m_{equil}. against √t for Zeolite No. 3 at 25° C. and 2% RP is shown in FIG. 5, together with the corresponding sorption kinetics as a function of stepwise RP (inset). Upon exposure of the outgassed zeolite powders to the dynamically flowing water vapor stream, there is a steep increase in sample mass as a consequence of surface water adsorption (inset). This fast process is generally complete within ca. 10 min which is then followed only by water diffusion into the intracrystalline voids. This is the starting reference point from which the D is calculated (m₀=0 at t=0). As the dynamic adsorption progresses, the rate-limiting intracrystalline adsorption proceeds slowly until an equilibrium state is reached. This behavior also holds true for the adsorption occurring at other RP steps.

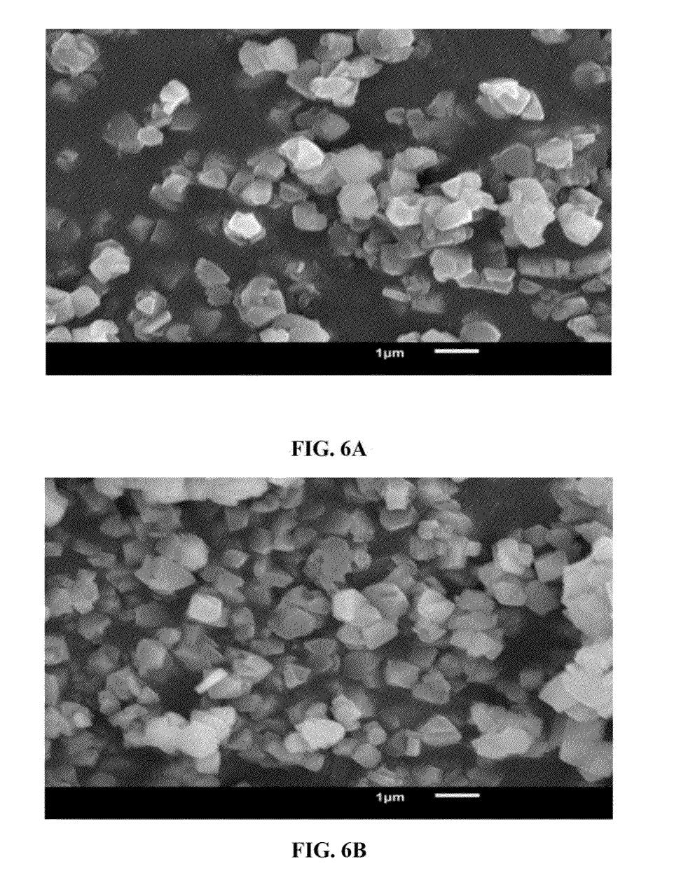

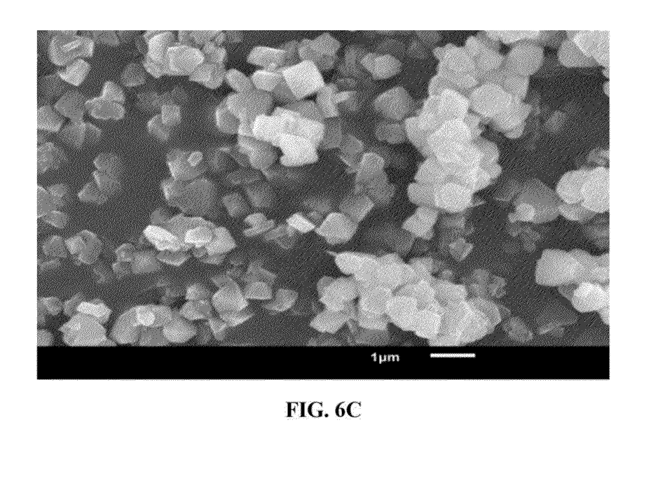

The particle size of these zeolites is estimated by SEM images (FIGS. 6A-C), demonstrating an average octahedral particle size of ˜1 μm, regardless of the tailoring methodology. Based on this estimated particle size, the regression (FIG. 5) gives a D of 1.94×10⁻¹² cm²/s using the 1^{st}-order coefficient of the polynomial fitted equation. The T-dependent Ds of the other zeolites are similarly calculated and summarized in Table 3 (regression curves not shown here for brevity). Both the 3D pore system and large-pore nature of FAU-type zeolites contribute to the appreciable Ds ranging from 10⁻¹³ to 10⁻¹² cm²/s, depending on the operating T and IED. An increase in D shown in Table 3 with testing T is expected since diffusion in the restricted geometries of zeolites is an activated transport process. In terms of IED dependency, the D rises with increasing IED due to the molecular traffic jam effect in the confined intracrystalline space of zeolites. See, E. G. Derouane, Z. Gabelica, J. Catal. 65 (1980) 486-489, which is incorporated by reference in its entirety. However, the D of No. 4 is an exception in regard to No. 2, which can be understood by a few locally occluded non-framework Al species extracted by calcination.

Characteristic Adsorption Energy:

The performance of AHPs is strongly relevant to the adsorption heat released by the activated zeolite adsorbents. The classic Dubinin-Radushkevich (D-R) equation provides fundamental adsorption information specifically in the micropores, which takes the form (see C. Nguyen, D. D. Do, Carbon 39 (2001) 1327-1336, which is incorporated by reference in its entirety)

$$V = {V}_{0} exp [ - {( \frac{RT}{β {E}_{0}} ln \frac{{P}_{0}}{p} )}^{2} ] \qquad ( 6 )$$

where V represents the volume of adsorbate condensed in micropores at P/P₀ (1-20%) and T (condensed adsorbate can be roughly considered as liquid-like one); V₀ is the total volume of accessible micropores by a given adsorbate at 100% RP; E₀ is the characteristic adsorption energy of an adsorbate with respect to a given solid; and the affinity coefficient β is the ratio of the adsorption potential of the adsorbate relative to a reference adsorbate (e.g., benzene). β is equal to 0.2 for water adsorbate.

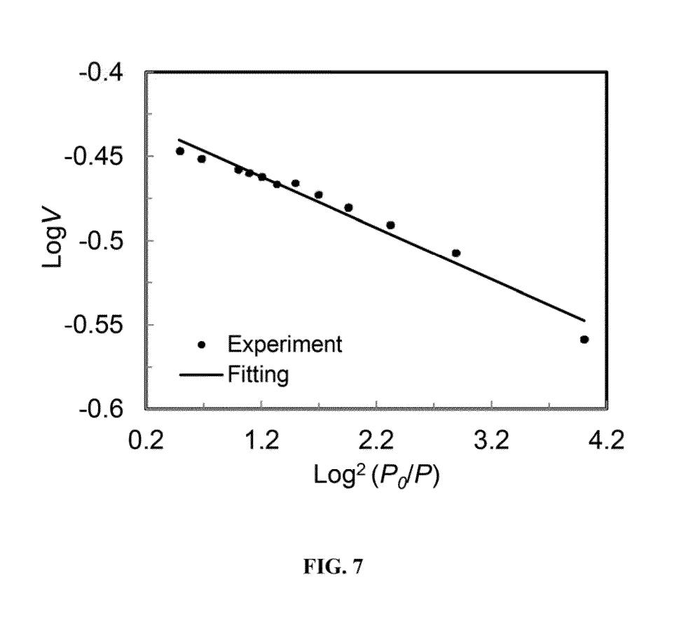

The D-R plot of the No. 3 zeolites at 25° C. for water vapor uptake is shown in FIG. 7 as an example but with the other D-R fittings omitted here for brevity. The effects of T on the regression coefficient (R²), V₀ and E₀ are summarized in Table 4, highlighting that both V₀ and E₀ are a weak function of T within the narrow T range of interest. After the linear D-R regression, the calculated V₀ is 0.375 ml/g along with an E₀ of −107.9 kJ/mol that is approximately 2.7 times the enthalpy of condensation for water (−40.7 kJ/mol). Obviously, the V₀ lies intermediate between V_{micro} (0.342 ml/g) and Vₜ (0.393 ml/g) both quantified by N₂ sorption analyses (Table 1). This means that water uptake at 100% RP takes place at three different locations inside Mg,Na—Y zeolites, i.e., the small cages, supercages and external surfaces/partial interstitial voids. It is commonly accepted that water is sequentially adsorbed in FAU-type zeolites in three RP-dependent steps corresponding to the adsorption around the charge-compensating cations, monolayer adsorption and condensation in the supercages. See, J. C. Moise, J. P. Bellat, A. Methivier, Micropor. Mesopor. Mater. 43 (2001) 91-101, which is incorporated by reference in its entirety. Nevertheless, these findings suggest that such a description is incomplete in cases where the condensation in the nanoscale intercrystalline voids cannot be totally ignored near the saturation pressure provided that the Sₑₓₜₑᵣₙₐₗ proportion cannot be neglected (7.4% herein). In faujasite zeolites, the cations in the small cages (at sites SI, SI′ and SII′; see C. W. Kim, K. J. Jung, N. H. Heo, S. H. Kim, S. B. Hong, K. Seff, J. Phys. Chem. C 113 (2009) 5164-5181, which is incorporated by reference in its entirety) are sterically inaccessible to N₂ molecules (3.64 Å), and so only the supercage cations (at SII, SIII and SIII′) are available to interact with the quadrupole moment of N₂. Instead, slim water molecules can have access to both small cages and supercages with an effective opening of 7.4 Å. See L. Broussard, D. P. Shoemaker, J. Am. Chem. Soc. 82 (1960) 1041-1051, which is incorporated by reference in its entirety. By comparing V₀ with V_{micro}, the adsorption quantity in the small cages takes up ˜8.8% of the total uptake in the micropores assuming the density of adsorbed water to be 1 g/ml. With reference to Vₜ (Table 1), a maximal water uptake of 42.6 wt % at 25° C. can be theoretically predicted over defect-free Mg,Na—Y zeolites (˜70% IED) while extrapolating RP to ˜100%, as experimentally corroborated in E.-P. Ng, S. Mintova, Micropor. Mesopor. Mater. 114 (2008) 1-26, which is incorporated by reference in its entirety. Furthermore, the monolayer-forming adsorption is already in close proximity to completion at ˜1% RP considering the calculated monolayer adsorption volume of 0.279 ml/g based on a BET fitting of the water adsorption isotherm branch within 5-20% RP (not shown here). Capillary condensation in the interstitial voids initiates at ˜69.3% RP, accounting for 12% of the total water adsorption amount at ˜100% RP and 25° C. On the other hand, as indicated in Table 4, the mean E₀ makes no significant difference between Nos. 2 and 3, which is compatible with their respective water uptake quantity. The E₀ of −105.2 kJ/mol on average is quite similar to the isosteric heats of adsorption at zero sorbate coverage of zeolites such as MgY, CuY, ZnY and BaY with water as the adsorbate. See, B. Coughlan, W. M. Carroll, J. Chem. Soc., Faraday Trans. 1, 72 (1976) 2016-2030, and J. C. Moise, J. P. Bellat, A. Methivier, Micropor. Mesopor. Mater. 43 (2001) 91-101, each of which is incorporated by reference in its entirety. This result is reasonable since the D-R equation delivers the most effective solutions to the problems linked to the dilute vapor adsorption occurring in microporous materials. Ion exchange to a greater extent enables the mean E₀ of No. 3 to improve by 34.4% in comparison to the parent No. 1 zeolites because the hydration enthalpy of Mg²⁺ counterions (−1923 kJ/mol) is much larger than that of Na⁺ ions (−418 kJ/mol). The tunability of E₀ could offer an attractive prospect for the creation of zeolite adsorbents with a high thermal energy storage density.

TABLE 4
Adsorption properties of the parent and modified zeolites
for water vapor based on the fitting with the D-R equation.

| Zeolite | T (° C.) | R² | V₀ (ml/g) | E₀ (kJ/mol) |
|---|---|---|---|---|
| No. 1 | 25 | 0.94 | 0.309 | −82.9 |
| | 45 | 0.98 | 0.320 | −76.8 |
| | 65 | 0.99 | 0.342 | −75.2 |
| No. 2 | 25 | 0.96 | 0.384 | −108.6 |
| | 45 | 0.98 | 0.391 | −102.7 |
| | 65 | 0.99 | 0.386 | −101.6 |
| No. 3 | 25 | 0.97 | 0.375 | −107.9 |
| | 45 | 0.98 | 0.383 | −106.4 |
| | 65 | 0.98 | 0.384 | −101.2 |

Vapor Uptake Performance for 20 wt % MeOH/H₂O Mixture:

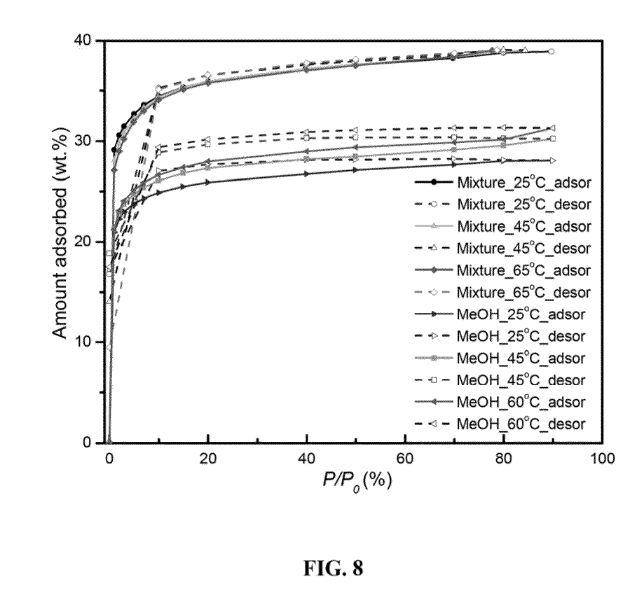

Pure water adsorbate in the evaporator and water reservoir may pose a significant risk of frosting or freezing in chilly winter seasons, thus disabling the operation of the AHPs. To circumvent this scenario, non-flammable 20 wt % MeOH aqueous solutions are examined besides pure water. Several important physical variables of the mixed vapor adsorbate as a function of T are presented in Table 5 along with those of water and MeOH for comparison. The blending of water with 20 wt % MeOH allows for the practice of AHPs at elevated total vapor pressure due to the lowered boiling point (BP) of the mixture (86° C.) and at depressed FP down to −18° C. In this case, the evaporator can be smoothly operated at a lower T (e.g., <0° C.), thereby promising improved cooling efficiency. Additionally, no significant reduction in water vapor partial pressure is observed upon dosing MeOH additive, showing small decreases of 6.2, 4.6, 4.3% at 25, 45 and 65° C., respectively. Therefore the mixed MeOH/H₂O adsorbate would not have a pronounced adverse impact on the water uptake properties of zeolites. The mixed and pure MeOH vapor uptake properties of No. 3 as functions of RP and T are shown in FIG. 8 and Table 6. FIG. 8 shows that the operational T has little influence on the total adsorption capacity for MeOH aqueous mixtures, as with water adsorbate (FIG. 4C). By comparing the data in Tables 6 and 3, the uptake capacity is nearly independent of adsorbate type. Meanwhile, the corresponding Ds at 2% RP for mixed vapor are slightly smaller than those for water vapor. As such, the water component plays a dominant role over MeOH in the competitive adsorption process, a favorable attribute in the pursuit of better-performing AHPs for chilly conditions.

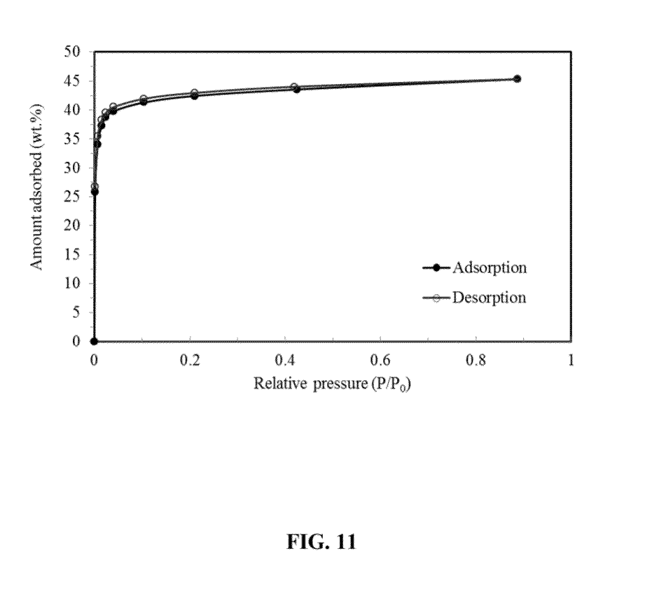

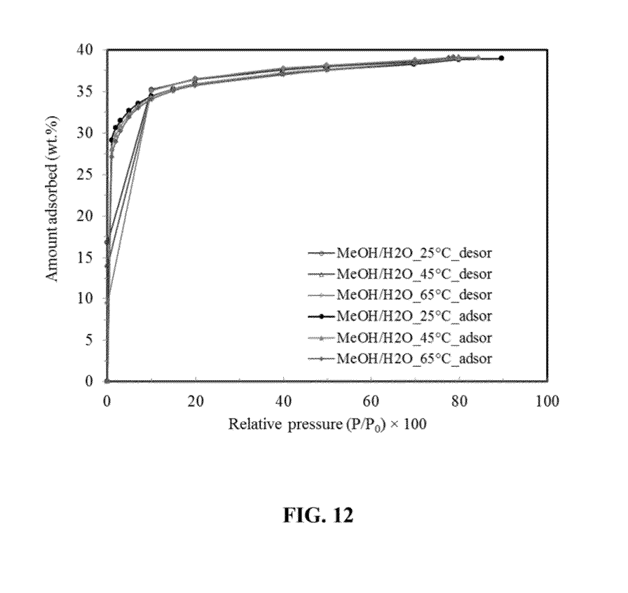

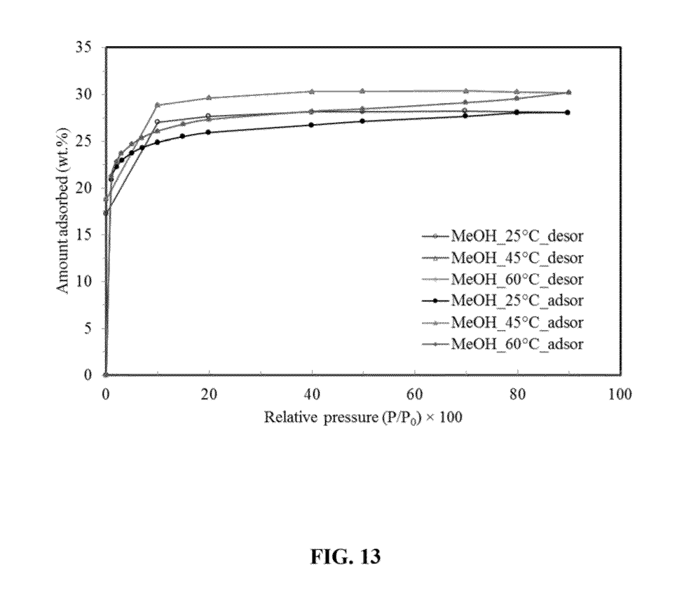

FIG. 11 shows water adsorption/desorption isotherms of MgY zeolites at 25° C. FIG. 12 shows adsorption/desorption isotherms of MgY zeolites at different running temperature for 20 wt % methanol aqueous solutions. FIG. 13 shows adsorption/desorption isotherms of MgY zeolites at different running temperature for pure methanol.

TABLE 5
Representative physical parameters of the adsorbates of interest.

| | Saturation vapor | | | Vapor composition | | | | | |
|---|---|---|---|---|---|---|---|---|---|
| | pressure (P₀ in Torr) | | | (wt % H₂O) | | | BP | FP | LHC ^{a} |
| Adsorbate | 25° C. | 45° C. | 65° C. | 25° C. | 45° C. | 65° C. | (° C.) | (° C.) | (kJ/mol) |
| H₂O | 23.8 | 71.9 | 187.5 | 100 | 100 | 100 | 100 | 0 | −40.7 |
| 20MeOH/80H₂O | 44.9 | 128.9 | 320.3 | 35.8 | 39.0 | 41.7 | 86 | −18 | — |
| MeOH | 126.4 | 332.6 | 629.4 ^{b} | 0 | 0 | 0 | 64.7 | −97.6 | −35.3 |

^{a} LHC: Latent heat of condensation;
^{b} Data at 60° C. to prevent MeOH boiling at a typical T of 65° C.

TABLE 6
Uptake capacity and D of No. 3 for 20 wt % MeOH aqueous
mixture and MeOH at different Ts and RPs.

| | | Adsorption | | |
|---|---|---|---|---|
| | | capacity (wt %) | | |
| Adsorbate | T (° C.) | 2% RP | 90% RP | D at 2% RP (cm²/s) |
| MeOH/H₂O | 25 | 30.59 | 38.94 | 9.55 × 10⁻¹³ |
| | 45 | 29.77 | 39.06^{a} | 1.04 × 10⁻¹² |
| | 65 | 28.99 | 39.09^{b} | 1.53 × 10⁻¹² |
| MeOH | 25 | 22.25 | 28.06 | — |
| | 45 | 22.84 | 30.21 | — |
| | 60 | 23.08 | 31.28 | — |

^{a}Data at 84.4% RP;
^{b}Data at 78.7% RP.

Vapor Uptake Performance for MeOH:

To further evaluate the effect of the MeOH additive on water uptake properties, the uptake of pure MeOH vapor by No. 3 was investigated at various RPs and Ts (FIG. 8 and Table 6). For MeOH uptake, the adsorption capacity counter-intuitively increases with rising T. The main reason for this trend is that the steady-state adsorption of MeOH cannot be fully fulfilled only within the RP-specific sorption intervals identical to those for either water or MeOH/H₂O mixture, originating from more sluggish mobility of MeOH (3.8-4.1 Å in kinetic diameter; see J. E. ten Elshof, C. R. Abadal, J. Sekulic, S. R. Chowdhury, D. H. A. Blank, Micropor. Mesopor. Mater. 65 (2003) 197-208, which is incorporated by reference in its entirety) inside constrained spaces as opposed to water. The higher adsorption T favoring larger D promotes the faster approach towards the quasi-equilibrium of adsorption. Interestingly, upon desorption, an appreciable portion of MeOH molecules cannot be desorbed rapidly at low T despite the lower BP of MeOH compared to that of water. In this case, some MeOH molecules may condense with trace amounts of zeolite hydroxyl groups to form methoxyl entities that are hardly removable at low T even under vacuum. See, M. Stocker, Micropor. Mesopor. Mater. 29 (1999) 3-48, which is incorporated by reference in its entirety. Additionally, the exchanged Mg²⁺ ions probably in association with MeOH clusters to form stable [Mg(CH₃OH)ₙ]²⁺ or [MgOCH₃]⁺ adducts confined in the supercages are presumably another factor affecting the extent of desorption. See, C. A. Woodward, M. P. Dobson, A. J. Stace, J. Phys. Chem. A 101 (1997) 2279-2287, which is incorporated by reference in its entirety. As shown in Table 6, the adsorption capacity of No. 3 for MeOH adsorbate is inferior to those for both water (Table 3) and MeOH/H₂O mixture, further lending support to the above reasoning regarding quite low MeOH loading in the adsorbed phase inside zeolites in relation to water constituent.

### Synthetic Scalability and Cyclic Stability

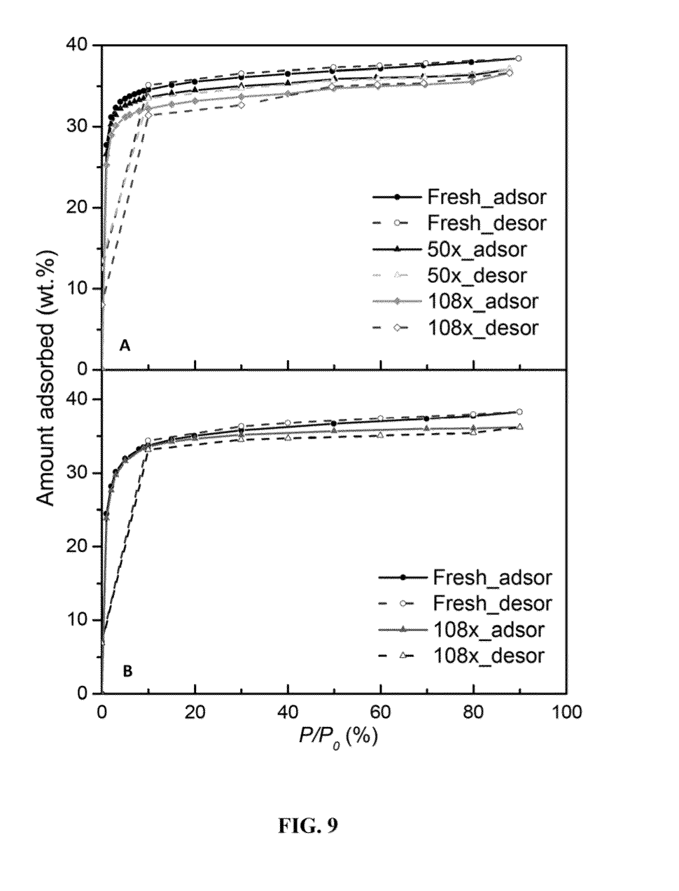

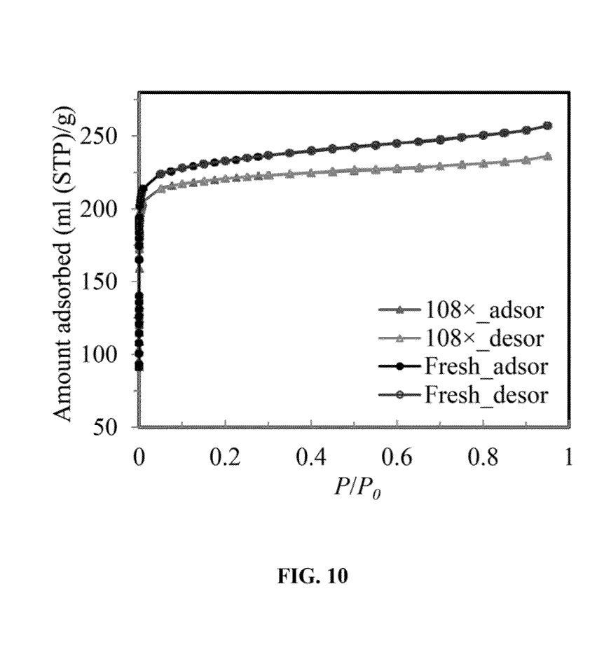

The adsorption/desorption cycling stability of zeolite adsorbents is critical to their practical viability in AHP systems. Sorption isotherms of Mg,Na—Y Zeolite No. 5 for water adsorbate at 25 and 65° C. before and after multiple cycles are plotted in FIGS. 9 A and B, respectively. Comparison of the sorption isotherms of No. 3 (FIG. 4C) and fresh No. 5 (FIG. 9A) both at 25° C. manifests the robust synthetic reproducibility from batch to batch in terms of sorption capacity, independently of the bench-top preparative scale. After 50× cycles, the water uptake quantities measured at 25° C. only deteriorate from 31.16 down to 30.28 wt % at 2% RP and from 37.90 down to 36.39 wt % at 80% RP, whereas the corresponding degradations are respectively 7.2% from 31.16 to 28.92 wt % and 6.2% from 37.90 to 35.54 wt % after undergoing 108× cycles (FIG. 9). In contrast, after 108× cycles, degradation rates of only 2.05 and 4.5% at 2 and 80% RP, respectively, are observed while experimenting at 65° C. (FIG. 9B). To gain some insights into the slight degradation in performance, N₂ sorption analyses are performed on No. 5 before and after 108× cycles (FIG. 10 and Table 1). After multiple cycles, there is a subtle loss of microporosity, as reflected by the variations in both V_{micro} and S_{micro}. The slight framework dealumination provoked by water attack at the cyclic T maximum of 250° C. is likely the major cause of the minor drop in these textural parameters, and consequently leads to the slight deterioration in water uptake capacity. Another influential factor is the agglomeration or sintering of micro-sized zeolite particles at elevated T, leading to a 45% decline in Sₑₓₜₑᵣₙₐₗ after 108× cycles. Nevertheless, sorption kinetic trials reveal that the D of water vapor is rather susceptible to the number of structural defect sites and the extent of particle aggregation, both of which are responsible for the reduction in D by 15% at 65° C. and 2% RP (but still as much as 1.23×10⁻¹² cm²/s after 108× cycles). In summary, the Mg,Na—Y zeolites are proven to be hydrothermally stable against multiple adsorption/desorption cycles given the aggressive cycling conditions adopted here.

Other embodiments are within the scope of the following claims.

What is claimed is:

1. A thermo-adsorptive battery comprising:
an adsorbent comprising a multivalent cation-exchanged zeolite; and
an adsorbate.

2. The thermo-adsorptive battery of claim 1, wherein the multivalent cations are selected from the group consisting of Mg²⁺, Zn²⁺, Cu²⁺, Ca²⁺, Sr²⁺, Ba²⁺, Al³⁺, and Fe³⁺.

3. The thermo-adsorptive battery of claim 1, wherein the zeolite is dealuminated by a weak acid.

4. The thermo-adsorptive battery of claim 3, wherein the weak acid is selected from the group consisting of H₄EDTA, Na₂H₂EDTA, HCOOH, CH₃COOH and oxalic acid.

5. The thermo-adsorptive battery of claim 1, wherein the zeolite is desilicated by a base.

6. The thermo-adsorptive battery of claim 5, wherein the base is selected from the group consisting of NaOH, KOH, LiOH, Ca(OH)₂, tetramethylammonium hydroxide (TMAOH), tetramethylammonium hydroxide (TEAOH), tetrabutylammonium hydroxide (TBAOH) and tetrapropylammonium hydroxide (TPAOH).

7. The thermo-adsorptive battery of claim 1, wherein the zeolite is calcined under a dry gas atmosphere.

8. The thermo-adsorptive battery of claim 7, wherein the dry gas is selected from the group consisting of vacuum, ammonia, N₂, air, O₂, He, and Ar.

9. The thermo-adsorptive battery of claim 7, wherein the zeolite is calcined at 400-600° C.

10. The thermo-adsorptive battery of claim 1, wherein the zeolite is hybridized with a nano metal oxide.

11. The thermo-adsorptive battery of claim 10, wherein the nano metal oxide includes MgO, CaO, BaO, or combinations thereof.

12. The thermo-adsorptive battery of claim 10, wherein the nano metal oxide is in the form of nanospheres, nanofibers, nanocones, or nanostars.

13. The thermo-adsorptive battery of claim 1, wherein the adsorbate includes water, methanol, ethanol, or combinations thereof.

14. The thermo-adsorptive battery of claim 1, wherein the adsorbate includes water and methanol.

15. The thermo-adsorptive battery of claim 1, wherein the adsorbate includes at least 20% of methanol, water and ethanol, or at least 20% of ethanol.

16. An adsorbent comprising a multivalent cation-exchanged zeolite.

17. The adsorbent of claim 16, wherein the multivalent cations are selected from the group consisting of Mg²⁺, Zn²⁺, Cu²⁺, Ca²⁺, Sr²⁺, Ba²⁺, Al³⁺, and Fe³⁺.

18. The adsorbent of claim 16, wherein the zeolite is dealuminated by a weak acid.

19. The adsorbent of claim 18, wherein the weak acid is selected from the group consisting of H₄EDTA, Na₂H₂EDTA, HCOOH, CH₃COOH and oxalic acid.

20. The adsorbent of claim 16, wherein the zeolite is desilicated by a base.

21. The adsorbent of claim 20, wherein the base is selected from the group consisting of NaOH, KOH, LiOH, Ca(OH)₂, TMAOH, TEAOH, TBAOH and TPAOH.

22. The adsorbent of claim 16, wherein the zeolite is calcined under a dry gas atmosphere.

23. The adsorbent of claim 22, wherein the dry gas is selected from the group consisting of vacuum, ammonia, N₂, air, O₂, He, and Ar.

24. The adsorbent of claim 22, wherein the zeolite is calcined at 400-600° C.

25. The adsorbent of claim 16, wherein the zeolite is hybridized with a nano metal oxide.

26. The adsorbent of claim 25, wherein the nano metal oxide includes MgO, CaO, BaO, or combinations thereof.

27. The adsorbent of claim 26, wherein the nano metal oxide is in the form of nanospheres, nanofibers, nanocones, or nanostars.

28. A heating and cooling system comprising the adsorbent of claim 16.

29. A desiccant for a liquid-/gas-mixture separation comprising the adsorbent of claim 16.

30. A method of making a thermo-adsorptive battery comprising:
preparing a zeolite as an adsorbent; and
ion-exchanging the zeolite with multivalent cations.

31. The method of claim 30, wherein the multivalent cations are selected from the group consisting of Mg²⁺, Zn²⁺, Cu²⁺, Ca²⁺, Sr²⁺, Ba²⁺, Al³⁺, and Fe³⁺.

32. The method of claim 30, wherein the zeolite is calcined under a dry gas atmosphere.

33. The method of claim 30, further comprising dealuminating the zeolite with a weak acid.

34. The method of claim 33, wherein the weak acid is selected from the group consisting of H₄EDTA, Na₂H₂EDTA, HCOOH, CH₃COOH and oxalic acid.

35. The method of claim 30, further comprising desilicating the zeolite with a base.

36. The method of claim 35, wherein the base is selected from the group consisting of NaOH, KOH, LiOH, Ca(OH)₂, TMAOH, TEAOH, TBAOH and TPAOH.

37. The method of claim 32, wherein the dry gas is selected from the group consisting of vacuum, ammonia, N₂, air, O₂, He, and Ar.

38. The method of claim 41, wherein the zeolite is calcined at 400-600° C.

39. The method of claim 30, further comprising hybridizing the zeolite with a nano metal oxide.

40. The method of claim 39, wherein the nano metal oxide includes MgO, CaO, BaO, or any combinations thereof.

41. The method of claim 40, wherein the nano metal oxide is in the form of nanospheres, nanofibers, nanocones, or nanostars.
